(19) United States
(12) Patent Application Publication
(10) Pub. No.: US 2017/0008812 A1
(43) Pub. Date: Jan. 12, 2017

(54) PLANT NUTRIENT COMPOSITION FOR SYNERGISTICALLY INCREASING FLAVORS AND IMPROVING TEXTURES OF FRUITS AND FRUIT VEGETABLES AND METHOD THEREFOR

(71) Applicant: JAHNGRYU INDUSTRIES.,LTD, Cheongu-si (KR)

(72) Inventors: Woo Sung KIM, Chungcheongbuk-do (KR); In Kook CHANG, Chungcheongbuk-do (KR)

(21) Appl. No.: 15/120,712

(22) PCT Filed: Mar. 4, 2015
(86) PCT No.: PCT/KR2015/002059

§ 371 Date: Aug. 22, 2016

(30) Foreign Application Priority Data
Mar. 4, 2014 (KR) 10-2014-0025765

(51) Int. Cl. C05C 11/00; C05G 3/00; A01N 45/00

(52) U.S. Cl. CPC C05C 11/00; A01N 45/00; C05G 3/00

(57) ABSTRACT

A plant nutrient composition of the present invention can produce high-quality fruits or fruit vegetables which cause substantially no chemical damage, have no antagonistic action of each component in crops, synergistically increase inherent flavors of fruits through interactions of nitrogen and calcium, and improve textures, by performing foliage spray through a specific range of weight ratio of total nitrogen and water-soluble calcium, the spray concentration, and the spray amount when fruits or fruit vegetables are cultivated.

### TECHNICAL FIELD

The present invention relates to a plant nutrient composition which is able to synergistically increase the flavors of fruits and fruit vegetables while improving the textures thereof and is able to accelerate a harvest maturity along with the synergistically increased flavors and the improved textures thereof without inhibiting the hypertrophy of pears.

### BACKGROUND ART

In order to enhance quality during the cultivation of plants and maximize the crop thereof, a nutrient prepared by mixing in balance a variety of components may be supplied to soil or foliage. If the plants fail to absorb enough nutrients from the soil due to an imbalance, an antagonistic action, etc. of each nutrient in the soil, a method can be effectively used, wherein plant nutrients are diluted with water and are sprayed to stems, leaves, and fruits. This method can be used when it needs to quickly supplement nutrients in an effort to improve the lack of specific nutrient components, the slow growths and the quality of the plants.

These nutrients, for example, an inorganic substance, for example, nitrogen, phosphoric acid, potassium, magnesia, manganese, boron, iron, molybdenum, zinc, copper, calcium, etc., and an organic compound, for example, urea, a polymer nitrogen compound, an amino acid fertilizer, an organic phosphoric acid, an organic acid potassium, an organic phosphorus, carbohydrate derivative, a phosphorous acid, vitamins, saccharides, an algae extract, a plant extract, etc. may be supplied to plants.

These components are being currently sold in the market as having effect, for example, on a growth acceleration of fruits and fruit vegetables, an increase in sugar contents, a coloring enhancement, a fruit set, a physiological stress prevention, a fruit hypertrophy, a fruiting enhancement, a quality improvement, a disease endurance improvement, a cold and freezing damage prevention, a tree vigor renewal, a rooting enhancement, an overgrowth retardation, a storing performance enhancement, a plant stress decrease, a flavor increase, and a taste increase, among which the thing that customers most considers, is a ‘taste’. The tastes of the fruit and the fruit vegetables are mainly determined by sugar contents, acidity, moistures, textures and smell or odor. The quality may be greatly dependent on tastes, namely, flavors that a person may feel eating.

The products which provide descriptions on smell, tastes, and flavors in plant nutrients, may contain an amino acid, an organic phosphoric acid, an organic acid potassium, an organic phosphorous, a carbohydrate derivative, a low molecular peptide, a phosphorous acid, a potassium hydroxide, a micro nutrients, an effect synergist, a plant bioactive agent, a combined vitamin, saccharide, sulfur amino acid, etc., but there may be products wherein the effects on flavors are small or flavors are degraded. Moreover, fruit farms have promoted flavors based on soil characters or environment, however once an orchard has been made, it is very hard to change soil characteristics or environment To this end, it urgently needs to develop a new plant nutrient composition which is able to synergistically promote flavors.

In case of a fruit tree growth, a fruit farm soil management and disease and insect pest prevention report (2002) on pears made by the horticulture research center of the Korean Rural Development Administration describes that when making a fruit farm, soils preferably contain pH 5.5˜6.5, 25˜35 g/kg of an organic substance, 200˜300 mg/kg of a phosphorous acid, 5˜6 cmol/kg of calcium in exchangeable cations, 1.2˜2.0 cmol/kg of magnesium, and 0.3˜0.6 cmol/kg of potassium, along with the amount of applied fertilizer. In case of the fruit trees, the effects due to the absorption and movement of nutrients may be different based on various conditions, for example, a soil physical character, a tree vigor, a soil slope, etc. For example, in case of pears, a urea fertilizer may be fed to foliage if any lack symptom occurs since nitric nutrients are over removed from sandy loam or sandy soil during a rainy season. If the nitric components are over fed to the fruit trees, branches may thicken, and the inside of the tree crown may lack a quantity of light, which may inhibit the growths of fruits, and the tastes of fruits may become bad, and the accumulated amount of calcium to the fruits may decrease, thus causing various physiological stresses, and storability may be degraded. Moreover, the growing period may prolong, so the harvest maturity may be delayed.

Moreover, the calcium in plants is involved in a physiological operation, for example, the activations of various enzymes, a protein synthesis, a selective absorption control of other ions in a cell membrane, etc. The calcium is coupled with a pectin compound in a cell wall, thus maintaining the stiffness of a cell wall and enhancing storability. If the aforementioned calcium lacks, the front ends of a leave may become a chlorosis, and a shoot growth may stop, and the plants may gradually turn brown and die, and the cells can be easily destroyed and become crumble, and storability may be degraded. Furthermore, if the calcium is excessive, other nutrient lack symptoms may occur due to an antagonist operation with other nutrients. For this reason, in some farms, a water-soluble calcium liquid prepared by dissolving a calcium chloride in water is supplied to foliage if fruits have physiological stresses due to an absorption lack of the calcium and an imbalance in movements.

When fruits and fruit vegetables are cultivated, not in season, in a vinyl house or a glass house without cultivating in a bare ground, it is impossible to cultivate under an environment, for example, temperature, moisture, amount of sunshine, which are appropriate to a plant physiology. In order to improve such an environment, a number of plant nutrients is being used. The currently used plant nutrients may resolve the problems related with a growth retardation, a sugar content decrease and a bad storability which occur due to the lacking environment factors, but in almost cases, the natural flavors of plants may become bad, and even though the sugar contents increase, the flavors may also become bad, and the textures may be degraded.

The nitrogen and calcium are necessary nutrition components. In the conventional technology, the nitrogen and calcium have been used to supplement the roles and functions of the two nutrition components by mixing nitrogen and calcium. There may be a lot of occasions wherein the plants providing bad flavors are cultivated. To this end, it has needed to carry out a research on the effects that the natural flavors of the fruits are synergistically enhanced, while improving textures during the cultivations using the vinyl house or the glass house, not cultivating in season the fruits, for example, pears, apples, etc. or fruit vegetables based on a specific ratio of the total nitrogen and the water-soluble calcium and the spraying concentration and the spraying amount.

Meanwhile, when urea is sprayed to the foliage of the plant, the ammonia generated by the decomposition of the urea on the surfaces of leaves may chemically harm the plants. In order to resolve such a problem, the international patent laid-open No. WO90/11262 describes a fertilizer sprayed to foliage which contains a stabilized urea as a main component. More specifically, it discloses a liquid fertilizer containing salt formed of the urea and bivalent cation. Moreover, as described in the US patent registration No. 4559076, the international patent laid-open No. WO90/11262, the EU patent No. EP 0 463 075 B1, the Korean patent laid-open No. 2009˜0018774, the Korean patent registration No. 0812633, the Korean patent laid-open No. 2003˜0062520 and, the description of a product wherein nitrogen and calcium are mixed, the conventional plant nutrient composition has effects wherein a fertilization effect can be enhanced, and any chemical injury is not found, but there is not any mention on the way to synergistically enhance the flavors of fruits and fruit vegetables or improve textures based on a specific ratio of the total nitrogen and water-soluble calcium and the spraying concentration and amount.

Moreover, the Japanese patent No. 1996301679 describes a method for dissolving urea at 50˜100° C. during the preparation and then mixing calcium chloride. However, if the calcium chloride is inputted after the urea has been dissolved in water, the temperature may automatically increase due to a heating reaction between the calcium chloride and water, by which the solubility with respect to water in two compounds may increase, so the mixing preparation of two substances may be easily carried out. Moreover, according to the above patent document, the absorption of the plants may become better under a condition where a mixing mole ratio of the urea and the calcium chloride is 1˜¼ of the calcium chloride with respect to the urea 1, preferably, under a condition wherein the urea is excessive by about ½ or 5%. Moreover, a growth promotion of a rice plant, vegetables, fruits and vegetables, and it has effect on a disease insect pest resistance promotion, a stem and leave growth of flowers and a calcium lack prevention effect of fruit trees, and a test with respect to a raising seeding, lawn, and tomato is disclosed, but there is not any mention on the way to synergistically increase the flavors of fruits and fruit vegetables and/or improve textures based on a specific ratio and concentration of nitrogen and calcium.

Moreover, in case of a pear tree, the report “Effect of GA paste Calcium Chloride on Tree Growth, Fruit Quality, and Storability of ‘Niitaka’ Pears” in the Korean horticulture 41(5):517˜522 issued in 2000 describes that the harvest maturity can be delayed since hardness is increased when calcium is fed to the foliage of the fruits to which a gibberellin paste rather than processing only the gibberellin paste. Therefore, since it may interfere with a harvest maturity promotion effect of the gibberellin, the calcium may be supplied, but it needs to feed a plant nutrient composition which is able to decrease the fruit ripening period.

Potassium is involved in various physiological and biochemical operations of plants and is able to promote the movements of assimilation products by accelerating the generation of ATP and is able to improve the growth of fruits and increase the sugar contents of the fruits. If the potassium is excessively absorbed, the fruits may ripen earlier, thus accelerating the harvest maturity. For this reason, the growing period may be decreased, thus producing small-sized fruits.

In case of nitrogen, calcium and potassium, the roots of a plant are supposed to absorb and use such components which are dissolved out by water in the soil, but a balanced absorption may be not carried out due to an antagonistic operation of nitrogen and calcium in the soil and an antagonistic operation of calcium and potassium therein. For this reason, in recent years, the products wherein nitrogen, calcium and potassium are mixed, are being used, however any effects on synergistically increasing flavors or accelerating pear harvest maturity are not known. It describes only on a quality improvement effect, for example, a growth promotion, a sugar content increase, etc. Here, the growth promotion may be mistakenly recognized as a harvest maturity acceleration, but the growth promotions of all fruits are referred to the facts where the number of cell enhancement. At the time such growths almost end, the starches accumulated in the fruits are going to turn sugar, which means that the fruits are ripening. If the growth is promoted and the growing period prolongs, the harvest maturity of the fruit may be slowed. Moreover, the ripening of the fruit is involved in ethylene which is referred to a plant hormone, but an accurate mechanism thereon is not known.

In the meantime, in order to promote coloring and shorten a harvest maturity using an ordinary fertilizer, the Korean patent laid-open No. 2005-0053238 describes a way to add enough phosphoric acid and potassium components to a fertilizer while avoiding the use of nitrogen fertilizers. Moreover, in order to promote coloring and guide a harvest maturity shortening, it also describes a way to add an organophosphoric acid, lysine and an algae extract which are selected from natural substances having a coloring acceleration effect and directly supply sugar, for example, oligosaccharides, sucrose, etc. In this case, a predetermined phenomenon, however, may occur, wherein the growth stops earlier and then the fruits starts ripening since necessary nitrogen and calcium which are necessary for the growths of the plants, are not fed if the potassium content increases due to the antagonistic operation. The fruits, for example, pear, apple, pine apple, etc. start ripening at the time the growths thereof are almost over, so the harvest maturity can be inevitably delayed if the growth promotion effect is high. More specifically, in case of pears, if the harvest maturity is accelerated since the contents of calcium decreases after the potassium has been excessively supplied while avoiding the use of nitrogen fertilizers as mentioned above, the hypertrophy ratio may decrease as compared to the non-treated occasion, and a predetermined phenomenon may occur, wherein the natural favor and textures are degraded.

The inventor of the present application has developed a plant nutrient composition and a method thereof, wherein the flavors of fruits and fruit vegetables can be synergistically improved while enhancing textures in such a way to adjust a specific mixing ratio of total nitrogen (N), water-soluble calcium (CaO) or total nitrogen, water-soluble calcium and water-soluble potassium (K₂O) and a spraying concentration and a spraying amount. Particularly, in case of pears, it is possible to shorten the harvest maturity without inhibiting the aforementioned effects and hypertrophy.

### DISCLOSURE OF INVENTION

Accordingly, it is an object of the present invention to provide a plant nutrient composition and a method therefor which are able to synergistically increase the flavors of fruits and fruit vegetables while enhancing the textures thereof.

It is another object of the present invention to provide a plant nutrient composition and a method therefor which are able to synergistically increase the flavors of fruits while enhancing textures and at the same time are able to shorten a harvest maturity without inhibiting a fruit hypertrophy.

It is further another object of the present invention to provide a plant nutrient composition and a method therefor wherein a harvest maturity acceleration effect can be enhanced thanks to a gibberellin treatment during the cultivation of pears using a gibberellin, whereupon a good quality pear can be harvested earlier even when Korean thanksgiving day comes earlier, and a labor distribution effect can be obtained.

To achieve the above objects, there is provided a plant nutrient composition which may include the total nitrogen (T-N) of a nitrogen compound and a water-soluble calcium (CaO) of a calcium compound at a weight ratio of 1:0.8 to 1:3, and preferably at 1:1 to 1:2, and more preferably at 1:1.1.

The plant nutrient composition may include a nitrogen compound and a calcium compound for the concentration of the total nitrogen in a spraying liquid during the spraying to foliage to be 115˜460 mg/L and the concentration of the water-soluble calcium to be 125˜500 mg/L.

In case of the cultivation of pears, the plant nutrient composition may further include a potassium compound at a specific ratio and concentration of the nitrogen compound, the total nitrogen of the calcium compound and the water-soluble calcium.

The plant nutrient composition may include a water-soluble potassium concentration of 10˜200 mg/L in the plant nutrient composition.

### Advantageous Effects of the Invention

The plant nutrient composition according to the present invention does not actually cause any chemical damage when the total nitrogen and water-soluble calcium are sprayed to foliage at a predetermined ratio and a spraying concentration and a spraying amount during the cultivations of fruits and fruit vegetables, and each nutrient can be absorbed at a predetermined ratio into plants without any antagonistic operation, by means of which it is possible to produce high quality fruits and fruit vegetables which are able to synergistically increase the natural flavors of fruits while improving textures.

Moreover, the plant nutrient composition is able to accelerate a harvest maturity while maintaining an effect of synergistically increasing flavors and improving textures without inhibiting a fruit hypertrophy in such a way that a plant nutrient composition wherein potassium has been mixed at a specific ratio and a concentration of the total nitrogen and water-soluble calcium during the cultivation of pear, is sprayed to foliage during a growth period.

Furthermore, if the plant nutrient composition according to the present invention is used together with a gibberellin treatment during the cultivation of pears using a gibberellin, a harvest maturity acceleration effect can be enhanced thanks to a gibberellin treatment, so high quality pears can be harvested even though Korean thanksgiving day comes earlier, by which a labor distribution effect can be obtained.

### BRIEF DESCRIPTION OF DRAWINGS

FIG. 1A is a graph showing a statistic analysis data measured for 5 years from 2005 to 2009, wherein a maturity degree based on the lapse of days is measured after the flower of Niitaka pear has been in a full bloom cultivated at the fruit farms of the embodiment and comparison example, and FIG. 1B is a graph showing an evaluated data on a harvest maturity acceleration day calculated using a quadratic equation of y=0.0002x²−0.0378x+5.4032 between 125^{th} to 170^{th} days (the region A) after the flowers have been in a full bloom as seen from the graph.

### BEST MODES FOR CARRYING OUT THE INVENTION

The flavor may be obtained by a taste sense that a taste cell feels a predetermined substance dissolved in a mouth and a smell taste that a collenchyma cell of a nose feels a volatile substance and may be expressed in the form of a result after an individual effect as well as a combined operation. While a fruit, for example, pears, apples, etc. is ripening, a combined compound, for example, aldehyde, ester, terpene, amine, alcohol, ketone, lactone, a thiol group, etc. is biochemically synthesized. The flavor component of an ordinary fruit is based on an ester which is produced by a biological synthesis control of an esterase contained in fruits. In case of the volatile component, for example, ester, a hydrolysis and volatile substance are detected by a taste cell and a collenchyma cell, so the flavor can be felt, since the substrate and secretion of fruits are combined when chewing the fruits in the mouth. For this reason, when eating fruits, it is possible to feel the natural flavors of fruits in combination with sugar contents and acidity. Moreover, the textures of fruits may be good or bad based on a fruit hardness, a harvest maturity, a softness, the contents of stone cells, and a cell tissue.

The inventor of the present application has tested that a metabolism and biochemical phenomenon of a plant appear different based on a specific ratio of the total nitrogen (T—N) and the water-soluble calcium (CaO) and a spraying concentration and a spraying amount. To this end, the inventor has researched any scope wherein the flavor is synergistically increased and/or the texture is improved during the cultivation of pears or apples without causing any chemical damage to the plant in such a way to change the ratio and concentration of a nitrogen compound and a calcium compound and consequently completed this invention. Moreover, the inventor also has confirmed if a problem could be solved, wherein the natural flavors of fruits are degraded when the fruits are cultivated in a vinyl house or a glass house when the fruits are not in season. Moreover, the inventor has confirmed an effect where the aforementioned synergic effects can be obtained, and the harvest maturity can be accelerated without inhibiting any fruit hypertrophy in such a way that potassium is added by a predetermined amount under a specific ratio and concentration condition of the nitrogen compound and the calcium compound.

According to a detailed embodiment of the present invention, the nitrogen compound may be urea. The aforementioned urea may be an agricultural urea which is commercially available. It is preferred that the urea contains about 46% of nitrogen.

The calcium compound may be an industrial, food or agricultural calcium chloride. It is preferred that it contains over 72% of calcium chloride.

In case of a potassium compound, it is preferred that a potassium chloride or algae extract is used.

The nitrogen compound, calcium compound and potassium compound, however, are not limited to the aforementioned urea, calcium chloride, potassium chloride and algae extract. As another specific example, the nitrogen compound may be a single form of an organic nitrogen fertilizer, for example, urea, ammonia chloride, ammonium nitrate, ammonium sulfate, calcium nitrate, potassium nitrate, lime nitrogen, an amino acid, etc., and a combination form thereof. The calcium compound may be a single form of a calcium compound containing calcium, for example, calcium chloride, calcium carbonate, calcium hydroxide, calcium phosphate, calcium sulfate, calcium oxide, calcium acetate, calcium hydrogen phosphate, calcium dihydrogen phosphate, tricalcium phosphate, calcium cyanide, calcium nitrate, calcium fluoride, fish and shellfish, etc. or a combination thereof. The potassium compound may be a single form of potassium chloride, potassium nitrate, potassium sulfate, potassium hydroxide, potassium phosphate, an algae extract, etc. or may be a combination form thereof or may be used by substituting with a predetermined compound which is similar thereto.

The plant nutrient composition according to the present invention does not cause any chemical damage even though it is directly used to a root area of a plant, in particular to stems, leaves, and fruits of the plant. It can be easily dissolved in water without any sediment.

As a specific example, the plant nutrient composition may contain a total nitrogen and a water-soluble calcium at a weight ratio of 1:0.8 to 1:3 and preferably at 1:1 to 1:2 and more preferably 1:1.1.

As another specific example, in order to provide a flavor synergy effect and a texture improvement effect, it is preferred that the plant nutrient composition includes a nitrogen compound and a calcium compound for the concentration of the total nitrogen in a spraying liquid during the spraying to foliage to be 115˜460 mg/L and the concentration of the water-soluble calcium to be 125˜500 mg/L. Moreover, in order to provide a chemical damage prevention effect and the best chemical effect, it may include a nitrogen compound and a calcium compound for the concentration of the total nitrogen to be 115˜345 mg/L and the concentration of the water-soluble calcium to be 125˜375 mg/L. More preferably, it may include a nitrogen compound and a calcium compound for the concentration of the total nitrogen to be 230 mg/L and the concentration of the water-soluble calcium to be 250 mg/L.

As further another specific example, in case of a pear cultivation, the plant nutrient composition may further include a potassium compound within a weight ratio and concentration of a total nitrogen and a water-soluble calcium. In the aforementioned concentration range, the flavor can be synergistically increased, and the textures can be improved, without inhibiting a fruit hypertrophy, and a harvest maturity can be accelerated. The concentration of the water-soluble potassium may be 10˜150 mg/L, and preferably 10˜100 mg/L.

It is preferred that the plant nutrient composition is diluted in water to set a predetermined spraying concentration, and the spraying amount thereof is 500 L per 1600˜2000 m².

As further another specific example, the plant nutrient composition may further include one or more components selected from the group consisting of magnesium, manganese, boron, iron, molybdenum, zinc, and copper. For example, the plant nutrient composition may include, with respect to the total weight of the composition, 0.1˜10% by weight of magnesium, 0.05˜1% by weight of manganese, 0.01˜3% by weight of boron, 0.01˜0.5% by weight of iron, 0.0005˜0.1% by weight of molybdenum, 0.01˜0.5% by weight of zinc, and 0.01˜0.5% by weight of copper. Moreover, a predetermined additive, for example, a spreader, a surfactant, a pH adjuster, etc. may be further added so as to enhance the aforementioned effects.

As further another specific example, the plant nutrient composition may be used for a cultivation treated with a gibberellin, for which it is possible to enhance a harvest maturity thanks to a gibberellin treatment.

If the formulation of the plant nutrient composition is a liquid phase, it can be prepared in such a way that a nitrogen compound corresponding to 3˜30% by weight of the total nitrogen is dissolved in water, and a calcium compound corresponding to 3˜30% by weight of a water-soluble calcium is dissolved in the thusly obtained solution, and a potassium compound or an algae extract corresponding to 0.5˜20% by weight of a water-soluble potassium is further dissolved so as to enhance a harvest maturity acceleration effect. Moreover, if the formation of the composition is a solid form, it can be solidified in such a way to mix the liquid composition with a predetermined adjuvant.

As for the use time of the plant nutrient composition, it may be used during the whole growth periods. It may be sprayed once or twice a month. In case of a fruit, for example, pears, apples, etc., a first spraying may be carried out for a period of 14^{th} to 40^{th} days from the full blooming, and a second spraying may be carried out for a period of 10^{th} to 30^{th} days after the first spraying, and a third spraying may be carried out for a period of 20^{th} to 40^{th} days after the second spraying. The number of sprayings may be reduced by one or two sprayings based on the nutrition state of a corresponding tree.

### MODES FOR CARRYING OUT THE INVENTION

The present invention will be described in detail in conjunction with the embodiments, and these embodiments are provided only for the illustrative purposes, so they should not be interpreted as limiting the present invention.

### EMBODIMENTS

### Experiment Targets and Physical Property Measuring Method

During the fruit cultivation, a fruit farm which was a standard in compliance with a fruit farm soil management and disease and insect pest prevention report (2002) on pears and apples issued by the horticulture research center of the Korean Rural Development Administration was selected as a field experiment. The field experiments in all the embodiments were carried out in such a way that one tree was selected as one replicated plot, and branches were selected based on a randomized block design while possibly matching to the North, South, East and South directions per replicated plot, and a chemical liquid was enough sprayed to leaves and fruits after the treatment chemical agent was prevented from being sprayed to other replicated plots. Here, the spraying amount was 500 L per 1600˜2000 m² in case of the actual spraying. Moreover, a blind experiment method was used so that a treatment content was not known during the inspection or measurement after the harvest was carried out.

The fruit weight in case of the following experimental inspection means the average weight per one pear after the harvest of the pears, and the sugar content, hardness and maturity represent the average values of the total inspected fruits. The sugar content was measured using the PAL-1 by the ATAGO company in such a way that two portions (two points were opposite to each other) of each fruit were cut through in a vertical direction (from the top to the bottom), thus measuring the fruit juices. The hardness was measured with respect to the two sides, more specifically, one side and the opposite side of the maximum transverse center portion per one fruit by using the hardness tester the cross section of which has a diameter of 7.8 mm. The fruit flavors, textures (fleshes) and maturity tests were carried out by three or more experts having ordinary skills in the art who ate the fleshes near the sugar content and hardness measurement portions.

Evaluation Method of Flavors

The three experts having ordinary skills in the art took part in the inspections after they had tasted the fruits having the flavor indexes of 0, 1, 2, 3, 4 and 5 so as to make identical the criteria with respect to the values thereof before the experiments were started. Moreover, the average values of the flavor indexes were evaluated using the total harvest amount in such a way that the number of fruits corresponding to each value were multiplied, and each value was added up.

Flavor index 0: No flavor

1: A concentration at which it was hard to feel if there was any flavor.

2: The minimum flavor concentration at which it was possible to feel any change in a recognition power of flavor.

3: A concentration at which it was possible to accurately feel the presence of a flavor.

(Common Fruit Flavors when Fruits were Cultivated and Produced Under Standard Soil Quality and Environment)

4: A concentration at which a flavor could be easily felt, and an ordinary person, not an expert, was able to feel the flavor feels good.

5: The maximum concentration at which the increase in the flavor did no more cause any further increase in the recognition power of a person.

Evaluation Method of Textures

The three experts having ordinary skills in the art took part in the inspection after they had the same criteria with respect to the level in such a way to chew the fruits corresponding to three classifications for textures before the experiments were started.

The textures (fleshes) were classified into three levels of “bad”, “usual” and “good”, and the total harvest ratios of corresponding classifications were indicated.

The texture “bad”: an occasion wherein when an expert having ordinary skill in the art ate a pear, he evaluated that the texture was bad since the pear was tough or soft to chew.

The texture “usual”: an occasion wherein the texture was neither good, nor bad.

“Good”: an occasion wherein a rough degree, a soft degree, etc. were good, so the texture was very good.

Evaluation Method of Maturity

The maturity degree index meant the maturity at the initial stages (seven days before the harvest) of the harvested pears and was classified into the levels of 1˜6.

Maturity degree index 1: a pear the flesh texture of which was not completely softened and which felt raw.

2: a pear the flesh texture of which was a little softened (20%), but it felt raw.

3: a pear the flesh texture of which was softened (50%), but it felt raw.

4: a pear the flesh texture of which was softened (80%), but it was not fully ripen.

5: a pear the flesh texture of which was completely softened, and it was fully ripen.

6: a pear the flesh texture of which got tender, and it was over ripen.

The harvest maturity which may be obtained when harvesting at the time of a non-treated harvest period, is in a range of 4 to 5. For this, the three experts having ordinary skills in the art carried out the experiments after the harvest maturity differences due to the increase of 0.1 in a range of 4˜5 were adjusted to the same criteria, and the average values were calculated by dividing all the inspection values by the amount of harvest.

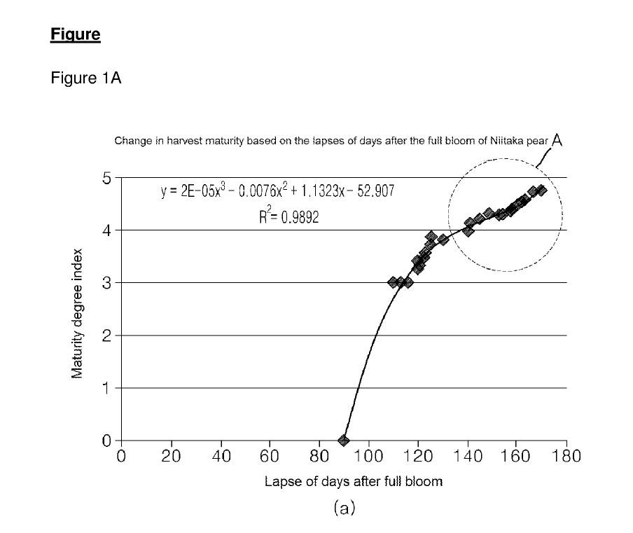

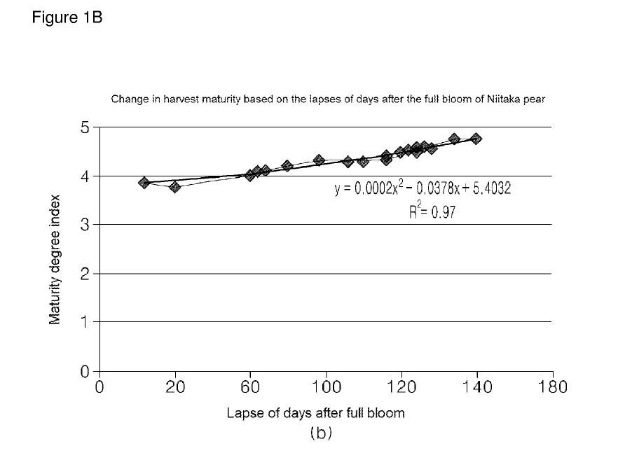

Moreover, the graphs in FIG. 1 show the statically analyzed values measured for five years from 2005 to 2009 with respect to the maturity based on the lapses of days after the full blooms of the Niitaka Pear which was cultivated at the fields like the fruit farms of the embodiments and the comparison examples. In the inspection method, the horizontal diameter based on the lapses of days was measured, and the average maturity of the fruit was measured, thus having generated a change curve. As evident from the graph in FIG. 1A, there was not any change in the maturity during the growing period of the pear until 90 days from the full bloom, but since then the maturity was sharply changed until about the 125^{th} day (the maturity 4), and the change speed from the maturity 4 to 4.7 was slow, thus having generated a fluent curve. In this way, the aforementioned graph was obtained via a regressing analysis with respect to the maturity accelerating days based on the maturity degree index after the maturity inspection was carried out. The maturity accelerating days were evaluated in such a way to calculate based on the quadratic equation y=0.0002x²−0.0378x+5.4032 between the 125^{th} to 170^{th} days after the full bloom in the graph of FIG. 1B.

### Embodiments 1 to 2 and Comparison Examples 1 to 3

The composition contains nitrogen formed of urea, a water-soluble calcium formed of a calcium chloride, and a water-soluble potassium formed of a potassium chloride for the composition to be sprayed to foliage at the concentration shown in the following table 1.

TABLE 1

| | Components of plant nutrient composition | | | |
|---|---|---|---|---|
| | Preparation | Preparation | Preparation | Preparation |
| Component | example 1 | example 2 | example 3 | example 4 |
| Total nitrogen | 230 | 0 | 230 | 60 |
| N(mg/L) | | | | |
| Water-soluble | 0 | 250 | 250 | 125 |
| calcium CaO(mg/L) | | | | |
| Water-soluble | 0 | 0 | 0 | 60 |
| potassium K₂O(mg/L) | | | | |

The above table 1 shows the component concentration of each plant nutrient composition when it is sprayed to foliage.

This experiment was carried out in such a way to randomly select two branches per direction (South and North) for each tree of Niitaka pear (17 years) located at Yeoceon-ri, Ohchang-up, Chungwon-gun, Cheongbuk, Korea in 2008, and the experiments were carried out based on a 5-tree replicated plot.

25 mg of the GA4+7 2.4% gibberellin paste (the brand name: Accellin) by JahnRyu industry Co. Ltd. was coated on the fruit stalk of the whole fruits before the composition was sprayed to foliage. Thereafter, it was first sprayed to foliage on June 23 at the concentration as seen in the table 1, and was second sprayed to the foliage on July 8, and the harvest was carried out twice from August 29 to September 5, and it was inspected. A result of the inspection is shown in Table 2.

TABLE 2

| | | State of | | | | |
|---|---|---|---|---|---|---|
| | | gibberellin | | | | |
| | Plant | coating | | | | |
| | nutrient | agent | Fruit | Sugar | | |
| | composition | treatment | weight (g) | content (Brix) | Hardness (kg) | Maturity |
| Comparison | Preparation | Treated | 743.1 | 12.3 | 1.76 | 4.51 |
| example 1 | example 1 | | | | | |
| Comparison | Preparation | Treated | 773.8 | 12.4 | 1.78 | 4.52 |
| example 2 | example 2 | | | | | |
| Embodiment 1 | Preparation | Treated | 784.2 | 12.2 | 1.80 | 4.52 |
| | example 3 | | | | | |
| Embodiment 2 | Preparation | Treated | 747.6 | 12.6 | 1.69 | 4.61 |
| | example 4 | | | | | |
| Comparison 3 | Not treated | Treated | 736.7 | 12.0 | 1.85 | 4.46 |

The table 2 shows the pear quality and maturity degree index based on each plant nutrient composition treatment.

Any chemical damage was not found in all the treatment plots. As seen in the result values of the embodiment 2 wherein the gibberellin Paste and the plant nutrients of the preparation example 4 were sprayed foliage, the hardness was decreased about 8.6% from 1.85 kg to 1.69 kg when a water-soluble potassium was mixed to a specific weight ratio of 1:2 of the total nitrogen and the water-soluble calcium as compared to when only the gibberellin (Accellin) was treated, and in case of the visual maturity inspection, the maturity degree index was changed from 4.46 to 4.61, which meant that about 5.4 days were shortened after the above data was substituted into the formula based on the graph in FIG. 1. Consequently, it was confirmed that the harvest maturity was shortened thanks to the plant nutrient composition, and it was checked whether there was further another effect due to the acceleration of the harvest maturity. As a result of the inspection, the quality in terms of the fruit hypertrophy and the sugar content increase was enhanced as compared to when only the gibberellin Paste was treated, whereupon if the present invention is used at a farm house which uses a gibberellin Paste, it is possible to enhance a gibberellin effect.

### Embodiments 3˜4 and Comparison Examples 4 and 5

The composition was prepared at the concentration of the following table 3 in such a way to mix a nitrogen formed of urea, a water-soluble calcium formed of a calcium chloride, and a water-soluble potassium formed of an algae extract (the brand name: Acadian) containing 17% of the water-soluble potassium registered as an organic agriculture agent in Canada.

TABLE 3

| | Components of plant nutrient composition | | |
|---|---|---|---|
| | Preparation | Preparation | Preparation |
| Components | example 5 | example 6 | example 7 |
| Total nitrogen N(mg/L) | 230 | 230 | 0 |
| Water-soluble calcium | 250 | 250 | 0 |
| CaO(mg/L) | | | |
| Water-soluble potassium K₂O | 0 | 35 | 35 |
| (mg/L) | | | |

The above table 3 shows the component concentration of each plant nutrient composition when it is sprayed to foliage.

This experiment was carried out in such a way to randomly select two branches per direction (South and North) for each tree of Niitaka pear (16 years) located at Yeocheon-ri, Ohchang-eup, Cheongwon-gun, Chungbuk, Korea in 2009, and the experiments were carried out based on a 5-tree replicated plot. It was treated at the concentrations in the table 3. Thereafter, as for the treatment, it was first sprayed to foliage 42 days after the full bloom, and was second sprayed 48 days after the first spraying, and the non-treated and all treated plots were harvested and inspected on October 12, and a result of the inspection is shown in Table 4.

TABLE 4

| | Plant nutrient | Fruit | Sugar | | | Lack of | Taste of |
|---|---|---|---|---|---|---|---|
| | compositions | weight (g) | content (Brix) | Hardness (kg) | maturity | flavor¹⁾ (%) | ferment²⁾ (%) |
| Comparison | Not treated | 570.5 | 11.9 | 1.61 | 4.71 | 45.8 | 23.7 |
| example 4 | | | | | | | |
| Embodiment 3 | Preparation | 570.2 | 12.1 | 1.65 | 4.71 | 26.2 | 11.9 |
| | example 5 | | | | | | |
| Embodiment 4 | Preparation | 587.2 | 12.0 | 1.52 | 4.83 | 23.3 | 14.0 |
| | example 6 | | | | | | |
| Comparison | Preparation | 563.1 | 12.0 | 1.58 | 4.79 | 37.7 | 30.2 |
| example 5 | example 7 | | | | | | |

¹⁾Lack of the flavor (%) is a fruit ratio (%) wherein the flavor index is smaller than 3 (0, 1, 2) in the whole harvest amount.
²⁾Taste of ferment (%) is a fruit ratio (%) when a flavor produced in the middle of fruit fermentation, namely, an alcohol flavor in the whole harvest amount is felt.

The table 4 shows a pear quality and maturity degree index based on the treatment of each plant nutrient composition treatment.

Any chemical damage was not found in all the treatment plots. The fruit harvest ratio that the product quality is degraded due to the lack of flavor and the taste of fermentation was 69.5% in case of the comparison example 4, and 67.9% in case of the comparison example 5, and 38.1% in case of the embodiment 3, and 37.3% in case of the embodiment 4. In the treatment plot wherein the total nitrogen and the water-soluble nitrogen were mixed at a specific weight ratio of 1:1.1 and a specific concentration, the lack of flavor (%), and the taste of fermentation (%) and the fruit ratio was decreased, which meant that the flavor was synergistically increased. When the total nitrogen and the water-soluble calcium were mixed, at a specific weight ration and a specific spraying concentration, with a water-soluble potassium in such a way to use an algae extract containing 17% of potassium in the embodiment 4, the hardness was decreased by about 5.6%, namely, from 1.61 to 1.52, and the maturity degree index was increased from 4.71 to 4.83. This values were substituted into the formula of the graph 1. As a result, it was confirmed that the harvest maturity was decreased about 3.6 days. In the comparison example 5 wherein only the algae extract containing potassium was sprayed, it was confirmed that the harvest maturity was accelerated due to the potassium, but the lack of flavor and the taste of fermentation were 23% higher than that in the embodiment 4 as a result of the investigation on the lack of flavor and the taste of fermentation, for which the product quality was degraded. In the comparison example 5, the fruit hypertrophy was smaller than the non-treatment. This meant that the harvest maturity acceleration effect was obtained thanks to the potassium, but the flavor synergy effect was not obtained. Consequently, it was known that when potassium was added to a specific weight ratio and a spraying concentration of the total nitrogen and the water-soluble calcium and was sprayed, the pears having good flavors and textures had an accelerated harvest maturity, not an inhibited fruit hypertrophy.

### Embodiments 5 to 7 and Comparison Examples 6 to 15

The composition was prepared using a nitrogen formed of urea, a water-soluble calcium formed of a calcium chloride, and a water-soluble potassium formed of a potassium chloride in order for the composition to be sprayed to foliage at the concentrations in the following table 5.

TABLE 5

| | Components of plant nutrient compositions | | | | | |
|---|---|---|---|---|---|---|
| | Preparation | Preparation | Preparation | Preparation | Preparation | Preparation |
| Components | example 8 | example 9 | example 10 | example 11 | example 12 | example 13 |
| Total nitrogen N (mg/L) | 0 | 0 | 0 | 230 | 460 | 920 |
| Water-soluble calcium | 125 | 250 | 500 | 0 | 0 | 0 |
| CaO (mg/L) | | | | | | |
| Water-soluble | 0 | 0 | 0 | 0 | 0 | 0 |
| potassium K₂O (mg/L) | | | | | | |
| | Components of plant nutrient compositions | | | | | |
| | Preparation | Preparation | Preparation | Preparation | Preparation | Preparation |
| Components | example 14 | example 15 | example 16 | example 17 | example 18 | example 19 |
| Total nitrogen N (mg/L) | 230 | 460 | 920 | 230 | 460 | 60 |
| Water-soluble calcium | 125 | 250 | 500 | 250 | 500 | 100 |
| CaO (mg/L) | | | | | | |
| Water-soluble | 0 | 0 | 0 | 0 | 0 | 60 |
| potassium K₂O (mg/L) | | | | | | |

The table 5 shows the component concentration of each plant nutrient composition when it is sprayed to foliage.

This experiment was carried out in such a way to randomly select two branches per direction (South and North) for each tree of Niitaka pear (20 years) located at Yeocheon-ri, Ohchang-eup, Cheongwon-gun, Chungbuk, Korea in 2011, and the experiments were carried out based on a 5-tree replicated plot. It was treated at the concentrations in the table 5. Thereafter, as for the treatment, it was first sprayed about 35 days after the full bloom, and was second sprayed 30 days after the first spraying, and was third sprayed 30 days after the second spraying. Moreover, On October 7 the non-treated and all treated plots were harvested, and all the harvests were weighed, and the sugar content, the hardness, the harvest maturity, the flavor, and the textures were inspected three days after the harvest with respect to all the fruits in the southern direction. Moreover, the fruits in the northern direction were stored at a room temperature, and the decays thereof were inspected 75 days thereafter, and a result is shown in the tables 6 and 7.

TABLE 6

| | Comparison | Comparison | Comparison | Comparison | Comparison | Comparison | Comparison |
|---|---|---|---|---|---|---|---|
| | example 6 | example 7 | example 8 | example 9 | example 10 | example 11 | example 12 |
| Plant nutrient | Preparation | Preparation | Preparation | Preparation | Preparation | Preparation | Preparation |
| composition | example 8 | example 9 | example 10 | example 11 | example 12 | example 13 | example 14 |
| Spotted | 1 | 2 | 2 | 0 | 0 | 0 | 1 |
| leave1¹⁾ | | | | | | | |
| Spotted | 0 | 0 | 0 | 0 | 0 | 0 | 0 |
| leave 2 | | | | | | | |
| Spotted | 0 | 0 | 0 | 0 | 0 | 0 | 0 |
| leave 3 | | | | | | | |
| Small | 1 | 1 | 2 | 0 | 1 | 1 | 1 |
| leave²⁾ | | | | | | | |
| Hardened | 0 | 0 | 3 | 0 | 0 | 0 | 0 |
| leave³⁾ | | | | | | | |
| Chemical | 0 | 0 | 0 | 0 | 0 | 0 | 0 |
| damage to | | | | | | | |
| fruit⁴⁾ | | | | | | | |

| | Comparison | Comparison | | | | |
|---|---|---|---|---|---|---|
| | example 13 | example 14 | Embodiment 5 | Embodiment 6 | Embodiment 7 | Comparison |
| Plant nutrient | Preparation | Preparation | Preparation | Preparation | Preparation | example 15 |
| composition | example 15 | example 16 | example 17 | example 18 | example 19 | Not treated |
| Spotted | 2 | 1 | 2 | 0 | 0 | 0 |
| leave1¹⁾ | | | | | | |
| Spotted | 0 | 3 | 0 | 0 | 1 | 0 |
| leave 2 | | | | | | |
| Spotted | 0 | 0 | 0 | 0 | 0 | 0 |
| leave 3 | | | | | | |
| Small | 1 | 2 | 1 | 3 | 1 | 3 |
| leave²⁾ | | | | | | |
| Hardened | 0 | 0 | 0 | 0 | 0 | 0 |
| leave³⁾ | | | | | | |
| Chemical | 0 | 0 | 0 | 0 | 0 | 0 |
| damage to | | | | | | |
| fruit⁴⁾ | | | | | | |

The table 6 shows the leaves of Niitaka pear and chemical damage to fruits based on each plant nutrient composition.

In the table 6, in case of the spotted leave, the small leave, and the hardened leave, the number of the branches having chemical damages is shown.

¹⁾ Spotted leave 1: an index which means that a growth does not have any problem (an index which may naturally generate).

Spotted leave 2: an index which means that a growth may have a problem (a spot index due to weak chemical damage).

Spotted leave 3: an index which means that a growth is likely to have a problem (an index wherein a spot is likely to occur due to a chemical damage).

²⁾ An occasion wherein a person having ordinary skill in the art may feel that the leaves of a Niitaka pear tree are small.

³⁾ an occasion wherein the edges of a leave are dried and rolled up.

⁴⁾ An occasion wherein a fruit is burnt or a chemical trace remains or any deformation has occurred.

In case of a chemical damage to fruits, it was not found in all the treatment plots. In the comparison example 8, when only the calcium chloride was treated at a higher concentration, a phenomenon occurred, wherein the leaves were hardened, and in the comparison example 14 and the embodiment 6, when a nitrogen was added, a chemical damage, which had been occurred due to the use of a calcium chloride, was not found. Moreover, the spotted leave phenomenon was most occurred in the comparison example 14, which means that it was possible to know a chemical damage might occur weakly based on the weight ratio and spraying concentration of the total nitrogen and the water-soluble calcium.

TABLE 7

| | Comparison | Comparison | Comparison | Comparison | Comparison | Comparison | Comparison |
|---|---|---|---|---|---|---|---|
| Plant nutrient | example 6 | example 7 | example 8 | example 9 | example 10 | example 11 | example 12 |
| preparation | Preparation | Preparation | Preparation | Preparation | Preparation | Preparation | Preparation |
| composition | example 8 | example 9 | example 10 | example 11 | example 12 | example 13 | example 14 |
| Fruit | 642 | 668 | 673 | 690 | 683 | 683 | 651 |
| weight (g) | | | | | | | |
| Sugar | 13.5 | 13.0 | 13.2 | 13.5 | 13.2 | 13.2 | 13.0 |
| content (Brix) | | | | | | | |
| Hardness (kg) | 1.71 | 1.68 | 1.71 | 1.73 | 1.68 | 1.69 | 1.51 |
| Maturity | 4.46 | 4.51 | 4.51 | 4.47 | 4.59 | 4.59 | 4.72 |
| degree | | | | | | | |
| Average | 2.86 | 3.21 | 3.00 | 3.09 | 2.67 | 2.79 | 2.87 |
| flavor | | | | | | | |
| Increase in | 0.15 | 0.5 | 0.29 | 0.38 | −0.04 | 0.08 | 0.16 |
| flavor¹⁾ | | | | | | | |
| Flavor | — | — | — | — | — | | −0.37 |
| synergistic | | | | | | | |
| increase or | | | | | | | |
| offset effect²⁾ | | | | | | | |
| Room | 33.3 | 30.8 | 46.2 | 33.3 | 45.5 | 35.0 | 27.8 |
| temperature | | | | | | | |
| storage | | | | | | | |
| decay ratio | | | | | | | |
| (%) | | | | | | | |

| | Comparison | Comparison | | | | |
|---|---|---|---|---|---|---|
| Plant nutrient | example 13 | example 14 | Embodiment 5 | Embodiment 6 | Embodiment 7 | Comparison |
| preparation | Preparation | Preparation | Preparation | Preparation | Preparation | example 15 |
| composition | example 15 | example 16 | example 17 | example 18 | example 19 | Not treated |
| Fruit | 664 | 674 | 689 | 698 | 686 | 655 |
| weight (g) | | | | | | |
| Sugar | 13.1 | 13.1 | 13.4 | 13.5 | 13.4 | 13.0 |
| content (Brix) | | | | | | |
| Hardness (kg) | 1.66 | 1.80 | 1.69 | 1.65 | 1.60 | 1.72 |
| Maturity | 4.55 | 4.50 | 4.53 | 4.48 | 4.67 | 4.53 |
| degree | | | | | | |
| Average | 2.64 | 2.87 | 3.67 | 3.31 | 3.08 | 2.71 |
| flavor | | | | | | |
| Increase in | −0.07 | 0.16 | 0.96 | 0.60 | 0.37 | — |
| flavor¹⁾ | | | | | | |
| Flavor | −0.39 | −0.21 | 0.06 | 0.35 | — | — |
| synergistic | | | | | | |
| increase or | | | | | | |
| offset effect²⁾ | | | | | | |
| Room | 40.0 | 38.9 | 22.2 | 22.2 | 35.7 | 38.9 |
| temperature | | | | | | |
| storage | | | | | | |
| decay ratio | | | | | | |
| (%) | | | | | | |

¹⁾Increase compared to non-treatment = average flavor of treatment plot − average flavor of non-treatment
²⁾Flavor synergistic increase or offset effect = flavor synergistic increase index of combined treatment of nitrogen and water-soluble calcium − (nitrogen treatment flavor synergistic increase index + water-soluble calcium flavor synergistic increase index)

A calculation example is as follows.

In case of the embodiment 5, the flavor index increase as compared to the non-treatment was 0.96, and the summed value of 0.38 of the flavor index of the comparison example 9 wherein only a nitrogen concentration corresponding thereto had been treated and of 0.5 when only a water-soluble calcium concentration had been treated, was 0.88.

It, therefore, was confirmed that there was a synergistic increase by 0.96−0.88=0.08.

The table 7 shows a pear quality and maturity degree index based on each plant nutrient composition treatment.

It was confirmed that when the weight ratio of the total nitrogen and the a water-soluble calcium was 1:0.54 as in the comparison examples 12 to 14, the flavor synergistic increase was rather dropped, which meant that the ratio of the water-soluble calcium should be over 0.54. As a result, when 230˜460 mg/L of the total nitrogen and 250˜500 mg of the water-soluble calcium were mixed and sprayed at a specific ratio of 1:1 of the total nitrogen and the water-soluble calcium, a fruit flavor synergistic increase effect was confirmed thanks to an interaction between nitrogen and calcium, and when 230 mg/L of the nitrogen and 250 mg/L of the water-soluble calcium were sprayed at a ratio of 1:1.1, the average index of the flavor was synergistically increased by 0.96 points as compared to the non-treatment. Moreover, according to the flavor increase or offset effect, it was confirmed that it was more increased at the ratio of the embodiment 5 rather than the flavor increase and decrease index was added, wherein only one nutrient between the nitrogen and the water-soluble calcium was treated. On the contrary, in case of the ratio of 1:0.54 as in the comparison examples 12 to 14, a minus value was obtained, which meant that there as an offset operation. More specifically, it was confirmed that a flavor synergy effect was increased at a specific ratio. Moreover, a storage performance was better at the room temperature storage decay ration (%) than the non-treatment and other treatment plots in the embodiments 5 to 6. Furthermore, even though the harvest maturity in the embodiment 7 has a specific ratio of the total nitrogen and the water-soluble calcium, if the composition is not sprayed within a specific range of the concentration, the flavor synergy effect may become weak, and only the harvest maturity may be accelerated. More specifically, in order to harvest earlier the pears which have good flavors for the sake of an earlier harvest, it is conformed that the potassium should be mixed within a range of specific ratios and spraying concentration of the total nitrogen and water-soluble calcium as in the embodiment 3.

### Embodiments 8 to 12 and Comparison Examples 16 to 20

Considering an occasion wherein the ratio of calcium chloride is higher as compared to the embodiments 5 to 7 and the comparison examples 6 to 15, the composition was prepared to be sprayed to foliage at the concentrations in the table 8 by mixing and using a nitrogen formed of urea, a water-soluble calcium formed of a calcium chloride, a water-soluble potassium formed of a potassium chloride, and a water-soluble boron formed of a boric acid. Moreover, in the preparation example 28, NH₄CL was used instead of the urea which had been used as a nitrogen component, and the content of nitrogen was same as when the urea had been used.

TABLE 8

| | Components of plant nutrient composition | | | | | | | | |
|---|---|---|---|---|---|---|---|---|---|
| | Preparation | Preparation | Preparation | Preparation | Preparation | Preparation | Preparation | Preparation | Preparation |
| Components | example 20 | example 21 | example 22 | example 23 | example 24 | example 25 | example 26 | example 27 | example 28 |
| Total nitrogen N | 0 | 0 | 115 | 230 | 115 | 230 | 230 | 230 | 230* |
| (mg/L) | | | | | | | | | |
| Water-soluble | 250 | 500 | 0 | 0 | 250 | 250 | 500 | 250 | 250 |
| calcium CaO (mg/L) | | | | | | | | | |
| Water-soluble | — | — | — | — | — | — | — | 25 | — |
| potassium K₂O | | | | | | | | | |
| (mg/L) | | | | | | | | | |
| Water-soluble boron | — | — | — | — | — | — | — | 1.2 | — |
| B ₂O₃ (mg/L) | | | | | | | | | |

The table 8 shows the component concentrations of each plant nutrient composition when it is sprayed to foliage.

This experiment was carried out in such a way to randomly select two branches per direction (South and North) for each tree of Niitaka pear (18 years) located at Yeocheon-ri, Ohchang-eup, Cheongwon-gun, Chungbuk, Korea in 2012, and the experiments were carried out based on a 5-tree replicated plot. It was treated at the concentrations in the table 9. Thereafter, as for the treatment, it was first sprayed about 38 days after the full bloom, and was second sprayed 16 days after the first spraying, and was third sprayed 30 days after the second spraying. Moreover, the non-treated and all treated plots were harvested and investigated on October 8, and a result is shown in the following table 9.

TABLE 9

| | Comparison | Comparison | Comparison | Comparison | Embodiment |
|---|---|---|---|---|---|
| | example 16 | example 17 | example 18 | example 19 | example 8 |
| Plant nutrient | Preparation | Preparation | Preparation | Preparation | Preparation |
| composition | example 20 | example 21 | example 22 | example 23 | example 24 |
| Fruit weight(g) | 633 | 669 | 670 | 681 | 661 |
| Sugar content(Brix) | 12.7 | 12.7 | 13.1 | 13.0 | 12.9 |
| Hardness(kg) | 1.78 | 1.76 | 1.81 | 1.76 | 1.83 |
| Maturity degree | 4.58 | 4.59 | 4.49 | 4.54 | 4.53 |
| Average flavor | 2.63 | 3.00 | 2.88 | 2.78 | 3.40 |
| Flavor synergistic | −0.27 | 0.1 | −0.02 | −0.12 | 0.5 |
| increase and | | | | | |
| decrease¹⁾ | | | | | |
| Flavor synergy or | — | — | — | — | 0.79 |
| offset effect²⁾ | | | | | |
| Texture ‘bad’ | 0 | 0 | 0 | 0 | 10 |
| ‘Usual’ | 100 | 36.4 | 87.5 | 33.3 | 30 |
| ‘Good’ | 0 | 63.6 | 12.5 | 66.7 | 60 |
| | Embodiment | Embodiment | Embodiment | Embodiment | |
| | example 9 | example 10 | example 11 | example 12 | Comparison |
| Plant nutrient | Preparation | Preparation | Preparation | Preparation | Example 20 |
| composition | example 25 | example 26 | example 27 | example 28 | Not treated |
| Fruit weight(g) | 677 | 638 | 661 | 661 | 664 |
| Sugar content(Brix) | 12.7 | 12.5 | 13.4 | 12.6 | 12.6 |
| Hardness(kg) | 1.81 | 2.22 | 1.61 | 1.91 | 1.96 |
| Maturity degree | 4.56 | 4.52 | 4.70 | 4.56 | 4.56 |
| Average flavor | 3.78 | 3.20 | 4.00 | 3.69 | 2.90 |
| Flavor synergistic | 0.88 | 0.3 | 1.1 | 0.79 | — |
| increase and | | | | | |
| decrease¹⁾ | | | | | |
| Flavor synergy or | 1.27 | 0.32 | 1.49 | 1.18 | — |
| offset effect²⁾ | | | | | |
| Texture ‘bad’ | 0 | 0 | 5.9 | 0 | 20 |
| ‘Usual’ | 22.2 | 30 | 23.5 | 53.8 | 70 |
| ‘Good’ | 77.8 | 70 | 70.6 | 46.2 | 10 |

¹⁾Increase as compared to non-treatment = average flavor of treatment plot − average flavor of non-treatment
²⁾Flavor synergistic increase or offset effect = flavor synergistic increase index of combined treatment of nitrogen and water-soluble calcium − (nitrogen treatment flavor synergistic increase index + water-soluble calcium flavor synergistic increase index)

A calculation example is as follows.

In case of the embodiment 9, the flavor index increase as compared to the comparison example 20 was 0.88, and the summed value of −0.12 of the flavor index of the comparison example 19 wherein only a nitrogen concentration corresponding thereto had been treated and of −0.27 when only a water-soluble calcium concentration had been treated, was −0.39.

It, therefore, was confirmed that there was a synergistic increase by 0.88−(−0.39)=1.27.

The table 9 shows a pear quality and maturity degree index based on each plant nutrient composition treatment.

Any chemical damage was not found in all the treatment plots. According to the above result, it was confirmed that as compared to the non-treatment, a fruit flavor was synergistically increased when the ratio of the total nitrogen and the water-soluble calcium was 1:(1.1˜2.2) in a range of 115˜230 mg/L of the total nitrogen and 250˜500 mg/L of the water-soluble calcium, of which when the ratio was 1:1.1, the best effect was confirmed. Moreover, according to a calculation of the flavor synergistic increase or offset effect, it was confirmed that there was more flavor synergistic increase effect at the 1:(1.1˜2.2) ratio treatment plot than when the flavor increase and decrease indexes were added, wherein any nutrient of the total nitrogen and the water-soluble calcium was treated. It was confirmed that when the ratio was 1:1.1, there was a higher flavor synergistic increase effect. Moreover, as a result of the texture “good” investigation, at the ratio 1:1.1 in the embodiment 9 and the embodiment 11, it was possible to harvest the pears the textures of which were good as 77.8% and 70.6% as compared to 10% of the non-treatment (a comparison example 20). Moreover, different from the embodiment 7, it was confirmed that the flavor and textures were good when the potassium was mixed at a specific weight ratio and a specific concentration range of the total nitrogen and the water-soluble calcium like in the embodiment 11. It was confirmed that the harvest maturity was accelerated by about 4.6 days when 4.70 was substituted into the formula of the graph 1 as compared to the harvest maturity of 4.56 of the non-treatment (a comparison example 20). The hardness was decreased by 17.8%, namely, from 1.96 kg to 1.61 kg. More specifically, when potassium was added to a specific weight ratio and concentration, the flavor synergistic increase effect was obtained and the textures became good. Moreover, the harvest maturity acceleration effect was obtained. Furthermore, as in the embodiment 12, the aforementioned effects were not greatly changed even though a potassium chloride was added instead of the urea which was contained in nitrogen.

Moreover, according to a resultant value of the treatment plot repeated in the embodiments 5 to 7 and the embodiments 8 to 12, the promotion and synergistic increase index range was different based on the conditions, for example, an environment when the experiment was conducted, soil, tree states, weather, etc., and as known from a result of the two experiments, both the promotion and synergistic increase were obtained, and the effects from the repeated experiments were recognizable.

### Embodiment 13 and Comparison Example 21

Considering a problem wherein the natural flavors of the fruits were degraded when the plants, which were not in season, were cultivated at a vinyl house or a glass house, an experiment in this embodiment was carried out so as to know if it was possible to resolve the problem using the composition of the present invention.

The plant nutrient composition containing the urea and calcium chloride of the preparation example 29 was prepared in such a way to mix the urea (46% of nitrogen) and calcium chloride (74%) with water at the contents shown in the following table 10.

TABLE 10

| | Urea | Calcium | | | |
|---|---|---|---|---|---|
| | (nitrogen | chloride | | Total | Dissolved |
| Components | 46%) | (74%) | water | amount | state |
| Added amount | 50 | 67.5 | 82.5 | 200 | good |
| (g) | | | | | |

The experiment was carried out in such a way to randomly select three branches per tree of Niitaka pear (19 years) in a vinyl house cultivation located at Bonggae-dong, Jeju-si, Jeju-do, Korea in 2013, and the experiments were carried out based on a 5-tree replicated plot. As for the treatment method, the composition of the preparation example 29 was diluted 500 times (w/v) and was sprayed to foliage. Here, the total nitrogen concentration of the foliage spraying was 230 mg/L, and the water-soluble calcium concentration was 252 mg/L. As for the treatment method, it was first sprayed 16 days after the full bloom, and was second sprayed 20 days after the first spraying, and the plants were harvested on September 12, and a result thereof is shown at Table 11.

TABLE 11

| Investigation items | Embodiment 13 | Comparison example 21 |
|---|---|---|
| Plant nutrient | Preparation example 29 | Not treated |
| composition | | |
| Sugar content(Brix) | 12.0 | 11.6 |
| Average flavor (%) | 3.53 | 2.53 |
| Texture ‘bad’ | 17.5 | 15.2 |
| ‘Usual’ | 50.1 | 78.7 |
| ‘Good’ | 32.4 | 6.1 |

The table 11 shows a result of the pear (Niitaka pear) flavor synergistic increase effect and texture comparison.

In the comparison example 21 wherein the plant nutrient same as in the preparation example 29 was not treated, the average flavor index was 2.53, and in the embodiment 13 wherein the total nitrogen and the water-soluble calcium were contained at a predetermined ratio, it was 3.53, which meant that there was about 39% increase. Moreover, “good” in the texture evaluation was 6.1% in the comparison example 21 wherein the plant nutrient composition was not treated, whereas it was higher as 32.4% in the embodiment 13. The flavors of the fruits and fruit vegetables lack or the textures are bad in case of the plants or fruits which are not in season and, in general, are cultivated for earlier harvests. Such problems can be resolved by using the composition of the present invention.

### Embodiment 14 and Comparison Example 22

The experiment was carried out in such a way to randomly select one branch per tree of Fuji apple (15 years) located at Seowon-ri, Samsung-myeon, Boeun-gun, Chungbuk, Korea in 2013, and the experiments were carried out based on a 10-tree replicated plot. As for the treatment method, the composition of the preparation example 29 prepared based on the contents of Table 11 was diluted 500 times (w/v) and was sprayed to foliage. Here, the total nitrogen concentration was 230 mg/L, and the water-soluble calcium concentration was 252 mg/L. It was first sprayed 20 days after the full bloom of the central flower, and was second sprayed 10 days after the first spraying, and all the fruits were harvested on October 28, and a result thereof is shown at Table 12.

TABLE 12

| Items of investigation | Embodiment 14 | Comparison example 22 |
|---|---|---|
| Plant nutrient | Preparation example 29 | Not treated |
| composition | | |
| Sugar content (Brix) | 15.2 | 14.9 |
| Average flavor (%) | 3.89 | 3.57 |
| Texture ‘bad’ | 0.9 | 13 |
| ‘Usual’ | 11.1 | 25 |
| ‘Good’ | 88 | 62 |

The table 12 shows a result of the apple (Fuji) flavor synergistic increase effect and texture comparison.

As a result of the embodiment 14 and the comparison example 22, it was confirmed that the average flavor was synergistically increased from 3.57 to 3.89 when the use of the composition was expanded to the apple (Fuji). The apples having good textures were increased by 26%, namely, from 62% to 88% as compared to the non-treated apples. Consequently, it was confirmed that the composition of the present invention could synergistically increase the flavors and textures in both the pears and apples.

1. A plant nutrient composition for synergistically increasing flavors and improving textures of fruits and fruit vegetables, comprising:
a nitrogen compound and a calcium compound, wherein the weight ratio of the total nitrogen of the nitrogen compound and the water-soluble calcium of the calcium compound is 1:0.8 to 1:3.

2. The composition of claim 1, wherein when the composition is sprayed to the foliage of a plant, the total nitrogen concentration of the nitrogen compound is 115˜460 mg/L, and the water-soluble calcium concentration of the calcium compound is 125˜500 mg/L.

3. The composition of claim 1, wherein the weight ratio of the total nitrogen content of the nitrogen compound and the water-soluble calcium of the calcium compound is 1:1 to 1:2, and when the composition is sprayed to the foliage of a plant, the total nitrogen concentration of the nitrogen compound is 115˜345 mg/L, and the water-soluble calcium concentration of the calcium compound is 125˜375 mg/L.

4. The composition of claim 1, wherein the composition further comprises a potassium compound, thus synergistically increasing flavors and improving textures without inhibiting the hypertrophy of fruits and fruit vegetables.

5. The composition of claim 4, wherein the weight ratio of the total nitrogen content of the nitrogen compound and the water-soluble calcium of the calcium compound is 1:0.8 to 1:3, and when the composition is sprayed to the foliage, the total nitrogen concentration of the nitrogen compound is 115˜460 mg/L, and the water-soluble calcium concentration of the calcium compound is 125˜500 mg/L, and the water-soluble potassium concentration of the potassium compound is 10˜150 mg/L.

6. The composition of claim 4, wherein the weight ratio of the total nitrogen content of the nitrogen compound and the water-soluble calcium of the calcium compound is 1:1 to 1:2, and when the composition is sprayed to the foliage, the total nitrogen concentration of the nitrogen compound is 115˜345 mg/L, and the water-soluble calcium concentration of the calcium compound is 125˜375 mg/L, and the water-soluble potassium concentration of the potassium compound is 10˜100 mg/L.

7. The composition of claim 1, wherein the use purpose of the composition is to synergistically increasing flavors and improving textures of the fruits and fruit vegetables which are not in season and are grown in a vinyl house or a glass house.

8. The composition of claim 1, wherein the nitrogen compound comprises one or more component selected from the group consisting of organic nitrogen fertilizer, for example, urea, ammonia chloride, ammonium nitrate, ammonium sulfate, calcium nitrate, potassium nitrate, lime nitrogen, and an amino acid, and the calcium compound comprises one or more component selected from the mixture group consisting of calcium, for example, calcium chloride, calcium carbonate, calcium hydroxide, calcium phosphate, calcium sulfate, calcium oxide, calcium acetate, calcium hydrogen phosphate, calcium dihydrogen phosphate, tricalcium phosphate, calcium cyanide, calcium nitrate, calcium fluoride, and fish and shellfish.

9. The composition of claim 4, wherein the potassium compound comprises one or more component selected from the group consisting of potassium chloride, potassium nitrate, potassium sulfate, potassium hydroxide, potassium phosphate, and an algae extract.

10. The composition of claim 1, further comprising one or more component selected from the group consisting of magnesium, manganese, boron, iron, molybdenum, zinc, and copper.

11. The composition of claim 10, wherein the composition comprises 0.1˜10% by weight of magnesium, 0.05˜1% by weight of manganese, 0.01˜3% by weight of boron, 0.01˜0.5% by weight of iron, 0.0005˜0.1% by weight of molybdenum, 0.01˜0.5% by weight of zinc, and 0.01˜0.5% by weight of copper.

12. The composition of claim 1, further comprising one or more component selected from the group consisting of a spreader, a surfactant, a pH adjuster, and other additives.

13. A method for synergistically increasing flavors and improving textures of fruits and fruit vegetables using a composition of claim 1.

14. A method for accelerating a harvest maturity by using together a plant nutrient composition of claim 1 and a gibberellin.

15. A method for using a plant nutrient composition of claim 1 to fruits, and stems, leaves or fruits of fruit vegetables.
